(19) United States
(12) Patent Application Publication
(10) Pub. No.: US 2008/0138610 A1
(43) Pub. Date: Jun. 12, 2008

(54) Film Or Sheet With Electrically-Conducting Coating Method For Production And Uses Thereof

(75) Inventors: Achim Neuhauser, Mainz (DE); Gunther Dickhaut-Bayer, Riedstadt (DE); Christoph Krohmer, Stockstadt (DE); Patrick Becker, Muhltal (DE); Rolf Neeb, Muhltal (DE); Ghirmay Seyoum, Egelsbach (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Roehm GmbH, Darmstadt (DE)

(21) Appl. No.: 11/814,704

(22) PCT Filed: Feb. 10, 2006
(86) PCT No.: PCT/EP06/01181

§ 371 Date: Jul. 25, 2007

(30) Foreign Application Priority Data
Feb. 23, 2005 (DE) 102005008550.4
Mar. 18, 2005 (DE) 102005013082.8

(51) Int. Cl. B32B 7/02; B05D 5/12

(52) U.S. Cl. 428/334; 427/58

(57) ABSTRACT

The invention relates to a process for production of foils or sheets composed of thermoplastic with electrically conductive coating by means of the following steps of a process: a) single-side coating of a backing foil composed of a thermoplastic with a lacquer composition based on silicon and comprising inorganic semiconductor particles, b) extrusion of an extrudate of a thermoplastic, c) bringing the coated side of the backing foil and the extrudate of the extruded thermoplastic together in the nip of the polishing stack, d) peeling of the backing foil from the composite, whereupon the coating of the backing foil remains on the extruded thermoplastic, e) if appropriate, cooling of the plastics web to ambient or room temperature. The invention further relates to the extruded and coated foils and sheets, and also to their uses.

The invention relates to a process for production of foils or sheets composed of thermoplastic with electrically conductive (antistatic) coating, to the foils and sheets, and also to their use.

### PRIOR ART

It is known that articles composed of plastic can accumulate electrical charges, for example via friction. The electrical charging can lead to numerous problems. Attraction for dirt particles or dust particles increases, and this can lead to unacceptable soiling of the items. Undesired discharges on photographic films can lead to discharge marks and render the films unusable. In electronic devices, static charging and static discharges can lead to malfunction. People can be exposed to electric shocks on contact with articles composed of plastic. Indeed, in extreme cases electrical discharges can cause dust explosions or ignition of highly flammable substances. For applications in critical sectors it is therefore desirable to counteract static charging of articles composed of plastic via earthing in the form of electrically conductive layers.

EP-B 0 447 603 describes antistatic coating compositions comprising a silicate solution and a conductive solution. The two solutions are mixed to bring about hydrolysis and polycondensation to give the coating compositions mentioned, which have chemical bonding between the silicate and the conductive material.

The coating compositions are thus suitable for production of antistatic antidazzle image-reproduction screens composed of a glass panel or of a plastics panel.

U.S. Pat. No. 4,571,361 describes antistatic plastics foils. Here, foils composed of, by way of example, cellulose acetate or polyethylene terephthalate are coated with polymerizable lacquer systems which can by way of example comprise antimony tin oxide particles. This gives foils with abrasion-resistant coatings and with low surface resistances in the range smaller than or equal to 107 D.

WO 96/40519 describes continuous production of plastics sheets with an embossed decorative matt structure by means of transfer lamination of a decorative surface film from a backing foil during the process to extrude the plastics sheet.

EP-A 0 193 269 relates to substrates which have been coated with silica particles. The coating is very uniform with respect to layer thickness, adheres exceptionally firmly to the substrate and has good antireflective properties.

U.S. Pat. No. 5,106,710 describes an electrographic process for generation of coloured images in a printer whose operation uses an electrostatic principle. Here, backing foils are first coated with the liquid pigmented print coating compositions, and these are dried, and the print is then transferred to another foil or sheet.

### OBJECT AND ACHIEVEMENT OF OBJECT

It is known that substrates such as glass or plastics products can be provided with inorganic layers which by way of example can have antistatic properties. Here, the coatings are generally applied to the substrate surface by means of lacquer systems, which can be cured via drying or polymerization. This gives coated substrates with entirely satisfactory properties with respect to abrasion resistance and, for example, electrical conductivity.

U.S. Pat. No. 4,571,361 describes antistatic plastics foils. Here, foils composed of, for example, cellulose acetate or polyethylene terephthalate are coated with polymerizable lacquer systems which can comprise, for example, antimony tin oxide particles. This gives foils with abrasion-resistant coatings and with low surface resistances in the range smaller than or equal to 10⁷Ω. The polymerizable lacquer systems are first applied to the foils via pouring, doctoring or lacquering, and are dried, and are then polymerized via exposure to ionizing radiation. The electrically conductive layers, based on polymerizable lacquer systems, can have the disadvantage of adhering exceptionally firmly to the substrate and therefore being of no practical suitability for a transfer process.

WO 96/40519 describes continuous production of plastics sheets with an embossed decorative matt structure by means of transfer lamination of a decorative surface film from a backing foil during the process to extrude the plastics sheet. Here, however, polymeric films are transferred, and nothing is to be found pointing towards foil transfer of electrically conductive layers on an inorganic basis.

An object was to provide a process that can extrude foils or sheets composed of thermoplastics and which can apply electrically conductive coatings continuously. The electrically conductive coating of the foils or sheets is intended to have at least acceptable to good abrasion resistance.

The object is achieved via a process for production of foils or sheets composed of thermoplastic with electrically conductive (antistatic) coating by means of the following steps of a process
a) single-side coating of a backing foil composed of a thermoplastic with a lacquer composition based on silicon oxide particles and on inorganic semiconductor particles in a solvent or a solvent mixture which, if appropriate, can also comprise a flow aid, by means of doctoring, flow coating, or dipping or continuous coating, and then drying of the coating,
b) extrusion of an extrudate of a thermoplastic whose softening point is the same as, or lower than, that of the thermoplastic of the backing foil, in an extrusion plant via a slot extrusion die for sheets or foils with downstream polishing-roll stack,
c) bringing the coated side of the backing foil and the extrudate of the extruded thermoplastic together in the nip of the polishing stack under pressure and at a roll temperature which is not more than 5° C. below the Vicat softening point of the extruded thermoplastic, thus producing a composite of the coated backing foil with the extrudate,
d) peeling of the backing foil from the composite at a temperature which is below the Vicat softening point of the extruded thermoplastic by at least 5° C., whereupon the coating of the backing foil remains on the extruded thermoplastic
e) cooling of the plastics web to ambient or room temperature, if this has not previously occurred in step d).

### WORKING OF THE INVENTION

The invention provides a process for production of foils or sheets composed of thermoplastic with electrically conductive (antistatic) coating, the foils and sheets, and their use.

### Test Methods

Molecular Weight M_{w}
Molecular weight M_{w} (weight-average) can by way of example be determined by gel permeation chromatography or by a scattered-light method (see by way of example H. F. Mark et al., Encyclopedia of Polymer Science and Engineering, 2nd Edition, Vol. 10, pages 1 et seq., J. Wiley, 1989).

Vicat Softening Point
Vicat softening point (VSP) is determined to DIN 306 B/50.

Grub Test
An example of equipment that can be used to determine the adhesion of the coating in the DIN 53778 wet-scrub test is the M 105/A wet-scrub tester from Gardner.

Surface Resistance
An example of equipment that can be used to determine the surface resistance of the coating to DIN EN 613402/IEC 61340 is an SRM-110 ohmmeter from Wolfgang Warmbier.

Particle Size Measurement
Particle size and particle size distribution car be determined by means of a laser extinction method. A Galay-CIS from L.O.T. GmbH can be used here, and the test method for determination of particle size and of particle size distribution is found in the user manual. The V₅₀ median particle size is the ponderal median at which 50% by weight of the particles have values smaller than or equal to this value and 50% by weight of the particles here have values greater than or equal to this value.

### The Process Encompasses at Least the Steps a) to e)

### Step a) of the Process

Step a) of the process encompasses (at least) single-side coating of a backing foil composed of a thermoplastic with a lacquer composition based on silicon oxide particles and on inorganic semiconductor particles, in particular with antimony or indium doped tin oxide particles (indium tin oxide particles or antimony tin oxide particles) in a solvent or solvent mixture which can, if appropriate, also comprise a flow aid.

The at least single-side coating process can take place by means of doctoring, flow coating or dipping (double-side coating) or preferably via continuous single-side coating (see by way of example WO 96/40519). The methods mentioned are known to the person skilled in the art. Once the lacquer composition has been applied it is dried to give a solid electrically conductive or solid antistatic coating.

### The Backing Foil

The backing foil is composed of a thermoplastic. Examples of suitable thermoplastics for the backing foil are polyamides, polycarbonates, polystyrenes, polyesters, such as polyethylene terephthalate (PET), where these may also have been modified with glycol, and polybutylene terephthalate (PBT), cyclo-olefinic copolymers (COCs,) acrylonitrile/butadiene/styrene copolymers and/or poly (meth)acrylates. Polyethylene terephthalate is preferred. The Vicat softening point of the plastic of the backing foil is to be at least the same as, but preferably higher than, that of the extruded plastic for the foils or sheets, particularly preferably higher by at least 10° C., in particular higher by from 10 to 80° C.

An example of the thickness of the backing foil is the range from 20 μm to <1 mm, in particular from 20 to 250 μm. The width is advantageously to be at least the same as that of the extruded melt web, but it can also be wider or narrower.

### Lacquer Composition for Electrically Conductive Coating

The lacquer composition comprises silicon oxide particles and inorganic semiconductor particles, preferably inorganically doped tin oxide particles or indium oxide particles, in a ratio by weight of from 1:9 to 9:1.

The primary particle size of suitable inorganic semiconductor particles (electrically conductive metal oxides) is in the range from 1 to 80 nm. The inorganic semiconductor particles can also be present in the undispersed state as aggregates and agglomerates of primary particles and of aggregates, the particle size of the agglomerates here being up to 2000 nm or up to 1000 nm. The size of the aggregates is up to 500 nm, preferably up to 200 nm.

The median particle size of the inorganic semiconductor particles or of the primary metal oxide particles can be determined with the aid of a transmission electron microscope and in the case of the primary particles is generally in the range from 5 to 50 nm, preferably from 10 to 40 nm and particularly preferably from 15 to 35 nm. Other suitable methods for determining median particle size are the Brunauer-Emmett-Teller adsorption method (BET) or X-ray diffractometry (XRD). The primary particles can be present as aggregates or as agglomerates. Aggregates are secondary particles durably joined by way of sinter bridges. Aggregates cannot be separated via dispersion processes.

Examples of suitable inorganic semiconductor particles (metal oxides) are antimony tin oxide nanomaterials or indium tin oxide nanomaterials (ITOs), which have particularly good electrical conductivity. Doped variants of the metal oxides mentioned are also suitable. Appropriate products are obtained in high purity by the precipitation process or the sol-gel process and are available commercially from various producers. The median primary particle sizes are in the range from 5 to 80 nm. The products comprise a certain proportion of agglomerates and aggregates composed of individual particles. Agglomerates are secondary particles held together via Van der Waals forces, and are separable via dispersion processes.

It is preferable to use a colloidal solution of SiO₂ particles. From 1 to 2% by weight of SiO₂ and from 2.5 to 7.5% by weight of other inorganic particles are preferably present in a solvent or solvent mixture which, if appropriate, also comprises flow aid and water. By way of example, the concentration of the flow aid present can be from 0.01 to 2% by weight, preferably from 0.1 to 1% by weight.

For the purposes of the present invention, the term inorganic means that the proportion of carbon in the inorganic coating is at most 25% by weight, preferably at most 17% by weight and very particularly preferably at most 10% by weight, based on the weight of the inorganic coating. This variable can be determined by means of elemental analysis.

Organic binders, where these are, however, exclusively non-polymerizing organic binders, are preferably absent or, if they are present at all, present only in very small, non-critical amounts.

Lacquer compositions which comprise polymerizing organic components according to U.S. Pat. No. 4,571,361 (Kawaguchi et al. Feb. 18, 1986) are exclusions or exceptions, in particular in the sense of the wording of claim 1 of U.S. Pat. No. 4,571,361. Lacquer compositions which comprise ingredients or, respectively, substances which have unsaturated bonds which when exposed to irradiation can initiate a polymerization process or polymerize are therefore exclusions or exceptions. Binders in the sense of U.S. Pat. No. 4,571,361 which comprise ingredients or, respectively, substances which have unsaturated bonds which when exposed to irradiation can initiate a polymerization process or polymerize are therefore absent or are exclusions or exceptions.

Lacquer compositions according to U.S. Pat. No. 4,571,361 are unsuitable for the purposes of the invention because these develop excessive adhesion by virtue of the polymerization process on the backing foil and in the inventive process are then practically incapable of transfer to the polymer extrudate.

According to another aspect of the present invention, it is also possible to use silane condensates which comprise a colloidal solution of SiO₂ particles. These solutions can be obtained by the sol-gel process, in particular condensing tetraalkoxysilanes and/or tetrahalosilanes.

Aqueous coating compositions are generally prepared from the abovementioned SiO₂ compounds by using water in a sufficient amount for hydrolysis, i.e. >0.5 mol of water per mole of the groups intended for hydrolysis, e.g. alkoxy groups, to hydrolyse organosilicon compounds, preferably using acid catalysis Examples of acids that can be added are inorganic acids, such as hydrochloric acid, sulphuric acid, phosphoric acid, nitric acid, etc., or organic acids, such as carboxylic acids, organic sulphonic acids, etc., or acid ion exchangers, the pH of the hydrolysis reaction here generally being from 2 to 4.5, preferably 3.

The coating composition preferably comprises inorganic particles in the form of from 1 to 2% by weight, preferably from 1.2 to 1.8% by weight, of SiO₂ and from 2.5 to 7.5% by weight, preferably from 3 to 7% by weight, particularly preferably from 4 to 6% by weight of indium tin oxide particles or preferably antimony tin oxide particles in water as solvent. The pH has preferably been set within the alkaline range in order that the particles do not agglomerate. The particle size of these oxide particles is non-critical, but transparency is, however, particle-size-dependent. The size of the particles is preferably at most 300 nm, and in particular they are within the range from 1 to 200 nm, preferably from 1 to 50 nm. The combination of the SiO₂ particles with the antimony tin oxide particles appears to have a synergistic effect leading to coatings whose electrical conductivity is particularly good when comparison is made with coatings using the antimony tin oxide particles alone.

According to one particular aspect of the present invention, the colloidal solution is preferably applied at pH greater than or equal to 7.5, in particular greater than or equal to 8 and particularly preferably greater than or equal to 9.

Basic colloidal solutions are less expensive than acidic solutions. Furthermore, it is particularly easy to store basic colloidal solutions of oxide particles, and to store them for a long period.

The lacquer compositions or coating compositions described above can be obtained commercially with trademark Lucox® (Grace, Worms), Levasil® (Bayer, Leverkusen); Klebosol® (Clariant).

It is preferable that the flow aid mentioned is also present in order to promote good distribution of the particles, e.g. at a concentration of from 0.1 to 1% by weight, preferably from 0.3 to 0.5% by weight.

The lacquer composition can be mixed from individual components prior to use.

By way of example, it is possible to use a commercially available antimony tin oxide solution or suspension in water (solution 1) of strength from 10 to 15% by weight and to mix this with a ready-to-use silica sol solution (solution 2) and with a diluent solution (solution 3).

The silica sol solution can initially be in concentrated form, e.g. can comprise SiO₂ particles in the size range from 10 to 100 nm, preferably from 7 to 50 nm, and can take the form of an aqueous solution or, respectively, suspension which has been rendered alkaline and whose strength is from 20 to 30%. The concentrated solution can in turn be adjusted to the form of a ready-to-use solution (solution 2) of strength about 30% in H₂O. It is preferable to add a dispersion aid or a flow aid. By way of example, surfactants are suitable, and addition of [fatty alcohol+3 ethylene oxide, Genapol X 80] is preferred.

The coating composition can encompass other flow aids alongside the flow aid having anionic groups, examples being non-ionic flow aids. Among these, particular preference is given to ethoxylates, and in particular it is possible here to use esters, or else alcohols and phenols having ethoxy groups. Among these are nonylphenol ethoxylates, inter alia.

The ethoxylates in particular encompass from 0 to 20 in particular from 2 to 8 ethoxy groups. The hydrophobic radical of the ethoxylated alcohols and esters preferably comprises from 1 to 40, preferably from 4 to 22, carbon atoms, and it is possible here to use either linear or else branched alcohol and/or ester radicals.

Products of this type can be obtained commercially, for example with the trademark ®Genapol X80.

Addition of non-ionic flow aids is restricted to an amount which has substantially no disadvantageous action on the antistatic coating. The amount added to the coating composition will generally be from 0.01 to 4% by weight, in particular from 0.1 to 2% by weight, of one or more non-ionic flow aids, based on the total weight of the coating composition.

As diluent (solution 3), use may be made of demineralized water which has been adjusted to about pH 9.0 using NaOH. Here again, a flow aid can advantageously be present.

Flow aids having at least one anionic group are known to persons skilled in the art, and these flow aids generally have carboxy groups, sulphonate groups and/or sulphate groups. These flow aids preferably encompass at least one sulphonate group. Flow aids having at least one anionic group encompass anionic flow aids and amphoteric flow aids, which also encompass a cationic group alongside an anionic group. Among these, preference is given to anionic flow aids. Using anionic flow aids it is in particular possible to produce formable plastics products.

The flow aids having at least one anionic group preferably encompass from 2 to 20, particularly preferably from 2 to 0, carbon atoms, and the organic radical here can comprise either aliphatic or else aromatic groups. According to one particular aspect of the present invention, use is made of anionic flow aids which encompass an alkyl or cycloalkyl radical having from 2 to 10 carbon atoms.

The flow aids having at least one anionic group can have other polar groups, for example carboxy, thiocarboxy or imino, carboxylic ester, carbonic ester, thiocarboxylic ester, dithiocarboxylic ester, thiocarbonic ester, dithiocarbonic ester and/or dithiocarbonamide groups.

It is particularly preferable to use flow aids of the formula (I)

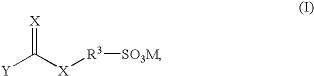

in which X is independently an oxygen or a sulphur atom, Y is a group of the formula OR², SR² or NR², in which R² is independently an alkyl group having from 1 to 5, preferably from 1 to 3, carbon atoms, and R³ is an alkylene group having from 1 to 10, preferably from 2 to 4, carbon atoms, and M is a cation, in particular an alkali metal ion, in particular potassium or sodium, or an ammonium ion.

Based on the total weight of the coating composition, from 0.01 to 1% by weight, in particular from 0.03 to 0.1% by weight, of one or more flow aids having at least one anionic group will generally be added to the coating composition.

Compounds of this type can in particular be obtained from Raschig AG with the trademark Raschig OPX® or Raschig DPS®, and at a concentration of from 0.1 to 1% by weight, preferably from 4.4 to 0.6% by weight, for example.

In order to obtain a ready-to-use coating composition, it is preferable to begin by mixing the solutions 2 and 3, for example 1n a ratio of from 1:1 to 1:2, for example 1:1.5, and then to mix the mixture with solution 1 in a ratio of about 1:1.

### Drying of the Lacquer Composition on the Backing Foil

Once the backing foil has been coated by means of doctoring, flow coating, dipping or continuous coating, the lacquer composition is dried. This can take place by way of example in the temperature range from 50 to 200° C., preferably from 80 to 120° C., and the temperature here needs to be appropriate to the heat resistance of the backing foil. A drying time of from 0.1 to 5 hours, preferably from 2 to 4 hours, is generally sufficient to obtain an almost completely hard coating. After the drying phase, a standing phase, e.g. from 12 to 24 hours at room temperature, can be inserted in order to ensure complete hardening before further use of the backing foil.

Because the lacquer layer has been produced from a solution which has a solids content composed of inorganic particles, the coating is composed of a continuous three-dimensional network which is composed of sphere-like structures and necessarily has a certain content of cavities. This structure is in principle known from EP-A 0 193 269.

### Step b) of the Process

Step b) of the process encompasses the extrusion of an extrudate of a thermoplastic whose softening point is the same as, or lower than, that of the thermoplastic of the backing foil, on an extrusion plant via a slot extrusion die for sheets or foils with downstream polishing-roll stack.

### Extruded Plastic

The extruded thermoplastic is preferably amorphous thermoplastic, in particular a polymethyl methacrylate, impact-modified polymethyl methacrylate, a polycarbonate, a polystyrene, a styrene-acrylonitrile plastic, polyvinyl chloride, transparent polyolefin, acrylonitrile-butadiene-styrene (ABS) plastic or a mixture (blend) of various thermoplastics.

The extruded amorphous thermoplastic is particularly preferably a polymethyl methacrylate whose Vicat softening point is in the range from 85 to 110° C., while the roll temperature used is from 80 to 140° C.

Polymethyl methacrylate plastics are homopolymers or copolymers composed of at least 80% by weight of methyl methacrylate and, if appropriate, up to 20% by weight of other monomers copolymerizable with methyl methacrylate. In particular, polymethyl methacrylates are composed of from 80 to 100% by weight, preferably from 90 to 99.5% by weight, of methyl methacrylate units polymerized by a free-radical route and, if appropriate, from 0 to 20% by weight, preferably from 0.5 to 10% by weight, of other comonomers capable of free-radical polymerization, e.g. C₁-C₄-alkyl (meth)acrylates, in particular methyl acrylate, ethyl acrylate or butyl acrylate. The average (weight-average) molar mass M_{w} of the matrix is preferably in the range from 90 000 to 200 000 g/mol, in particular from 100 000 to 150 000 g/mol (M_{w} being determined by means of gel permeation chromatography with reference to polymethyl methacrylate as calibration standard). By way of example, the molar mass M_{w} can be determined by gel permeation chromatography or by a light-scattering method (see, for example, H. F. Mark et al., Encyclopedia of Polymer Science and Engineering, 2nd Edition, Vol. 10, pages 1 et seq., J. Wiley, 1989).

A preferred copolymer is composed of from 90 to 99.5% by weight of methyl methacrylate and from 0.5 to 10% by weight of methyl acrylate. The Vicat softening points VSP (ISO 306-B50) can be in the range from at least 90° C., preferably from 95 to 112° C.

### Coextrusion

In individual cases, further improvement in adhesion or in durability of adhesion of the electrically conductive coating can be desirable. The thermoplastic used can be a limiting factor here. In that case, another layer of another thermoplastic can be applied by means of coextrusion to the plastic in question, on that side intended for the transfer of the electrically conductive coating. Using this method, it is possible to take a first plastic in which, for a particular application, the properties of the material do not achieve a certain adhesion or durability of adhesion of the electrically conductive coating, and to apply a layer which is composed of a second plastic and which permits better adhesion or durability of adhesion of the electrically conductive coating and thus complies with the increased requirements. Particularly good transfer or adhesion of the electrically conductive coating is in particular achieved with plastics whose Vicat softening point is equal to or below 120° C. Plastics within this range therefore have particularly good suitability as coextrusion layers on plastic with Vicat softening point greater than 120° C.

The respective plastics combinations here are intended to have adequate adhesion to one another. The adhesion between the two layers can be measured by means of a universal test machine (tensile test machine), by separating the two layers from one another in a 180° T-peel test configuration. For this, the specimens are preconditioned for 16 hours at 23° C. and 50% relative humidity. The test takes place under the same conditions. The 180° T-peel test is known to the person skilled in the art or to analysis practitioners. The width of the test specimen strip is 15 mm. The test velocity is 100 mm/min. The average force is determined during the progressive separation of the two layers. Adequate adhesion of coextruded layers can by way of example be present when the values measured for this peel force are greater than or equal to 1N, greater than or equal to 5N, greater than or equal to 15N or greater than or equal to 30N.

### Extrusion Plant

The extrusion plant in particular encompasses a slot extrusion die for sheets or foils and a downstream polishing-roll stack.

An extrusion plant is inter alia an extruder in which the plastic for the foils or sheets is first melted in the form of pellets and, as melt, is conveyed by means of a screw conveyor system into the slot extrusion die.

In the slot extrusion die, the plastics melt is distributed across the width before the melt in turn emerges as extrudate from the slot extrusion die. Using the method known per se here, it is possible to apply process conditions, temperatures and throughputs suitable for the respective plastic or to adapt procedures from within those known to persons skilled in the art. Appropriate extrusion plants are well known (see DE-A 37 41 793, EP 0 418 681 A2).

The emergent extrudate enters a polishing stack nip which is formed by two opposite rolls, the polishing roll stack. Because the polishing stack nip is set to be narrower than the extrudate, the extrudate is smoothed under pressure in the nip. The rolls simultaneously have the task of cooling the extrudate in a controlled fashion, and therefore generally have temperature control Downstream of the polishing stack nip there can be what is known as a calibrator, which cools the extrudate below the softening point.

Calibrator equipment is known by way of example from DE-C 32 44 953 (=EP-B 0 158 951) or from DE 198 04 235 (=EP-A 0 936 052). The continuously emergent extrudate can be wound up as a foil or, in the case of sheets, can be appropriately cut to length.

### Step c) of the Process

Step c) of the process encompasses bringing the coated side of the backing foil and the extrudate of the extruded thermoplastic together in the nip of the polishing stack, and at a roll temperature which is not more than 5° C. below the Vicat softening point of the extruded thermoplastic, and is preferably above the Vicat softening point of the extruded thermoplastic, thus producing a composite of the coated backing foil with the extrudate.

The method of bringing the coated side of the backing foil and the extrudate of the extruded thermoplastic together in the nip of the polishing stack consists in feeding of the backing foil into the nip. By virtue of the forces in the nip, the coated side of the backing foil and one side of the extrudate are pressed together in the nip. This produces a composite of the coated backing foil with the extrudate.

By way of example, the temperature of the extrudate on emerging from the slot extrusion die can be in the range from 200 to 280° C. The temperature at which the polishing stack has been set, or the roll temperature, i.e. either the temperature of both polishing stack rolls or the temperature at least of the roll on the inrunning backing foil side, is not more than 5° C. below the Vicat softening point of the extrude thermoplastic. The temperature of the roll on the inrunning backing foil side, or of both rolls, is preferably at least the temperature of the Vicat softening point of the extruded thermoplastic, or is 5, 10, 15, 20 or 30° C. thereabove, or from 5 to 30° C. thereabove. If only the temperature of the roll on the inrunning backing foil side is appropriately adjusted, the temperature of the opposite roll is preferably to differ by not more than 30° C. from that of the inventively temperature-controlled roll. In the case of extrusion of foils whose thickness is less than 1 mm, e.g. from 50 to 500 μm, it is preferable that both polishing stack rolls are appropriately temperature-controlled. In the case of sheets whose thickness is 1 mm or more, the temperature of the roll on the inrunning extrudate side is overall relatively non-critical. The temperature control of the polishing stack or the roll temperature of the polishing stack maintains the extrudate in a tacky condition in which the polymers probably to some extent intertwine with the electrically conductive layer of the backing foil. This bonding is overall stronger than the adhesion of the electrically conductive layer to the backing foil.

Step d) of the Process

In step d) of the process, the backing foil is peeled from the composite at a melt temperature which is below the Vicat softening point of the extruded thermoplastic by at least 10° C., preferably by from 20 to 50° C. The coating of the backing foil here remains on the extruded thermoplastic, or is transferred thereto. The abovementioned temperatures are present immediately after the nip or else at a certain distance from the nip. The backing foil can take place immediately after the polishing stack or preferably not until a certain distance from the polishing stack or from the nip has been reached. By way of example, the backing foil can be peeled at a distance of from 10 to 100 cm downstream of the nip by way of a deflector roll when the melt temperature is below the Vicat softening pint of the extruded thermoplastic by from about 20 to 50° C. Peeling in this region or temperature range is advantageous for process reliability. However, the foil can also, if appropriate, be peeled from the cooled web of foil or of sheet.

### Step e) of the Process

In step e) of the process, the plastics web is cooled to ambient or room temperature, e.g. to below 50° C., or from 20 to 40° C., if this has not previously occurred in step d). This gives foils or sheets with electrically conductive coating, and, by way of example, a finishing step can follow via wind-up of the foil or cutting to-length of the sheets to commercially available dimensions.

### Double-Side Coating

The coating can, if required, also be a double-side process, consisting in feeding of appropriately coated backing foils on both sides of the polishing stack nip in a manner corresponding to something like a mirror image, and transferring the layers to both sides of the extrudate.

### Foils and Sheets

The invention provides an extruded foil or sheet capable of production by the inventive process, characterized in that it is composed of a thermoplastic and has an electrically conductive coating whose surface resistance is smaller than or equal to 10¹⁰Ω, where the increase in this surface resistance after 5000 cycles of a scrub test to DIN 53 778 is not more than one power of ten.

By way of example the thickness of foils can be in the range from 50 μm to <1 mm, in particular from 60 to 250 μm.

By way of example, the thickness of sheets can be in the range from 1 mm to 200 mm, in particular from 3 to 30 mm.

Conventional width and length dimensions for foils sheets are in the range from 500 to 2000×2000 to 6000 mm (width×length).

The inorganic coating process can take place on one or more sides, as a function of the intended application.

The plastics product obtainable by the inventive process has an electrically conductive coating whose surface resistance is smaller than 10¹⁰Ω, preferably greater than or equal to 10⁹Ω but smaller than 10¹⁰Ω, particularly preferably greater than or equal to 10⁸Ω but smaller than 10⁹Ω, in particular greater than or equal to 10⁷Ω but smaller than 10⁸Ω, specifically greater than or equal to 10⁶Ω but smaller than 10⁷Ω. By way of example, the surface resistance of the coating can be determined to DIN EN 613402/IEC 61340 using an SRM-110 ohmmeter from Wolfgang Warmbier. This type of measuring device generally indicates a value by way of example smaller than 10¹⁰Ω for the surface resistance, and this what is meant by greater than or equal to 10⁹Ω but smaller than 10¹⁰Ω.

No Tyndall effect indicating haze is discernible. Rainbow interference effects which indicate non-uniform layer distribution are not discernible, or hardly discernible, on the coated surfaces.

The plastics product is preferably composed of a polymethyl methacrylate, i.e. of a polymer mainly composed of methyl methacrylate, or of a polystyrene The plastic can comprise additive and auxiliaries, such as impact modifiers, pigments fillers, UV absorber, etc. The plastics product can also be translucent or transparent.

The layer thickness of the electrically conductive coating is in the range from 200 to 5000 nm, preferably from 250 to 1000 nm, particularly preferably in the range from 300 to 400 nm.

The increase in the surface resistance of the inorganically coated, electrically conductive surface of the foil or sheet after 5000 cycles of a scrub test to DIN 53 778 is not more than one power of ten. In particular, examples of values that can be obtained after a scrub test are not more than greater than or equal to 10¹⁰Ω but smaller than 10¹¹Ω, preferably not more than greater than or equal to 10⁹Ω but smaller than 10¹⁰Ω, particularly preferably not more than greater than or equal to 10⁸Ω but smaller than 10⁹Ω, in particular not more than greater than or equal to 10⁷Ω but smaller than 10⁸Ω, and very particularly preferably not more than greater than or equal to 10⁶Ω but smaller than 10⁷Ω.

An example of equipment that can be used to determine the adhesion of the coating by the wet-scrub test to DIN 53778 is an M 105/A wet-scrub tester from Gardner.

By way of example, inventive films or sheets can be used for housings, for equipment, or for lamination foils, for lamination to components to be used in cleanrooms, e.g. in microbiological laboratories, in hospitals, or in rooms for production of wafers or of computer chips, for machine covers, for incubators, for displays, for display screens and display-screen covers, for rear-projection screens, for medical apparatus and for electrical devices.

The inventive foil or sheet may have been provided with other layers on the side opposite to the electrically conductive coating.

The other layers can be applied subsequently via lacquering or extrusion coating, or else during the inventive extrusion process via lamination or coextrusion. The other layers can provide functionalities beyond electrical conductivity, e.g. colouring, scratch resistance or mechanical strength.

### Advantageous Effects of the Invention

The inventive process permits continuous production of foils or sheets in the extrusion process with electrically conductive coating. The foils or sheets differ in the interior structure of the electrically conductive coating from the coatings of the prior art, because the consequence of the intimate contact of the coating with the extrudate in the molten state is that molecular intertwining or interpenetration occurs. The coating is therefore very abrasion-resistant.

The coating transferred from the coated substrate to the polymeric plastics product during its polymerization is of high quality. No Tyndall effect, which would indicate haze, is discernible. Rainbow interference effects which indicate non-uniform layer distribution are not discernible, or are hardly discernible, on the coated surface. Abrasion resistance is acceptable to good.

### EXAMPLES

### Example 1

### Inventive

25 parts by weight of an anionic silica sol (solids content 30%; Levasil® obtainable from Bayer AG) with 0.4 part by weight of an ethoxylated fatty-acid alcohol (®Genapol X80) were made up to 100 parts by weight with demineralized water and mixed in a ratio of 1:1.5 with a solution composed of 0.5 part by weight of the potassium salt of the 3-sulphopropyl ester of O-ethyl-dithiocarbonic acid; ®Raschig OPX obtainable from Raschig AG made up with aqueous NaOH solution at pH 9.5 to give 100 parts by weight.

50 parts by weight of this first solution were mixed with 50 parts by weight of an antimony tin oxide solution (12% strength in water; obtainable from Leuchtstoffwerk Breitungen GmbH).

The resultant lacquer was then coated by the manual doctoring process onto a foil of thickness of 50 μm composed of polyethylene terephthalate (PET, ®Melinex 401 obtainable from DuPont Teijin Films). The surface resistance exhibited by the coated side of the foil after the coating process was <10⁷Ω.

The resultant foil was then introduced during the production of a sheet of thickness 3 mm composed of polymethyl methacrylate (PMMA, copolymer composed of 96% by weight of methyl methacrylate and 4% by weight of methyl acrylate, Vicat softening point 103° C. according to Campus 4.5, measured at 10° C./min) on an extrusion plant with slot die, into the polishing stack nip, together with the extruded PMMA, the coated side then being turned towards the PMMA. The slot die was temperature-controlled to 260° C. The diameter of the rolls forming the polishing nip was 100 mm and they were temperature-controlled to 110° C. The take-off speed for the resultant sheets was 0.5 m/min. Once the composite had reached room temperature, the backing foil composed of PET was in turn peeled. The coating had transferred from the foil to the PMMA sheet. The surface resistance exhibited by the coated side of the sheet after the coating process was greater than or equal to 10⁶Ω and smaller than 10⁷Ω.

The sheets thus coated were then subjected to the wet-scrub test to DIN 53778 and even after 5000 cycles their surface resistance remained greater than or equal to 10⁷Ω and smaller than 10⁸Ω.

The sheet exhibited good optical properties.

### Comparative Example 1

Example 1 was repeated, but this time the temperature of the polishing stack rolls was reduced to 90° C. The surface resistance exhibited by the coated side of the sheet after the coating process was greater than or equal to 10⁶Ω and smaller than 10⁷Ω, and its optical quality was comparable with that of Example 1.

The adhesion of the coating proved to have durability similar to that in Example 1 and its surface resistance after 5000 cycles was likewise greater than or equal to 10⁸Ω and smaller than 10⁹Ω.

### Example 2

### Inventive

Example 1 was repeated, but this time the temperature of the slot die was reduced to 240° C. The surface resistance exhibited by the coated side of the sheet after the coating process was greater than or equal to 10⁶Ω and smaller than 10⁷Ω, and its optical quality was comparable with that of Example 1.

The adhesion of the coating proved to have durability similar to that in Example 1 and its surface resistance after 5000 cycles was likewise greater than or equal to 10⁷Ω and smaller than 10⁸Ω.

### Comparative Example 2

Example 2 was repeated, but this time the temperature of the polishing stack rolls was reduced to 90° C. The surface resistance exhibited by the coated side of the sheet after the coating process was greater than or equal to 10⁶Ω and smaller than 10⁷Ω, and its optical quality was comparable with that of Example 1.

The adhesion of the coating proved to be significantly less durable than in Example 2 and its surface resistance after 200 cycles was greater than or equal to 10¹⁰Ω and smaller than 10¹¹Ω.

1. Process for production of foils or sheets composed of thermoplastic with electrically conductive coating by means of the following steps of a process
a) single-side coating of a backing foil composed of a thermoplastic with a lacquer composition based on silicon oxide particles and on inorganic semiconductor particles in a solvent or a solvent mixture which, if appropriate, can also comprise a flow aid, by means of doctoring, flow coating, or dipping or continuous coating, and then drying of the coating,
b) extrusion of an extrudate of a thermoplastic whose softening point is the same as, or lower than, that of the thermoplastic of the backing foil, on an extrusion plant via a slot extrusion die for sheets or foils with downstream polishing-roll stack,
c) bringing the coated side of the backing foil and the extrudate of the extruded thermoplastic together in the nip of the polishing stack and at a roll temperature which is not more than 5° C. below the Vicat softening point of the extruded thermoplastic, thus producing a composite of the coated backing foil with the extrudate,
d) peeling of the backing foil from the composite at a melt temperature which is below the Vicat softening point of the extruded thermoplastic by at least 5° C., whereupon the coating of the backing foil remains on the extruded thermoplastic
e) cooling of the plastics web to ambient or room temperature, if this has not previously occurred in step d).

2. Process according to claim 1, characterized in that a colloidal solution of SiO₂ particles is used.

3. Process according to claim 1, characterized in that the lacquer composition comprises from 1 to 2% by weight of SiO₂ particles and from 2.5 to 7.5% by weight of antimony tin oxide particles in water as solvent.

4. Process according to one or more of claim 1, characterized in that the lacquer composition also comprises a surfactant or a mixture of surfactants as flow aid.

5. Process according to one or more of claim 1, characterized in that the backing foil is composed of a polyamide, polycarbonate, polystyrene, polyester, where these can also have been modified with glycol, polybutylene terephthalate (PBT), cyclo-olefinic copolymers (COCs), acrylonitrile/butadiene/styrene copolymers and/or a poly(meth)acrylate.

6. Process according to claim 1, characterized in that the extruded thermoplastic is a polymethyl methacrylate, impact-modified polymethyl methacrylate, a polycarbonate, a polystyrene, a styrene-acrylonitrile plastic, polyvinyl chloride, polyolefin, acrylonitrile-butadiene-styrene (ABS) plastic or a mixture (blend) of various thermoplastics.

7. Process according to claim 1, characterized in that the extruded thermoplastic is a polymethyl methacrylate whose Vicat softening point is in the range from 85 to 110° C., and the roll temperature is in the range from 80 to 140° C.

8. Extruded foil or sheet capable of production by a process according to claim 1, characterized in that it is composed of a thermoplastic and has an electrically conductive coating whose surface resistance is smaller than 10¹⁰Ω, where the increase in this surface resistance after 5000 cycles of a scrub test to DIN 53 778 is not more than one power of ten.

9. Foil or sheet according to claim 8, characterized in that the layer thickness of the electrically conductive coating is in the range from 200 to 5000 nm.

10. The method of using the foils or sheets according to claim 8 for housings, for equipment, or for lamination foils for lamination to components to be used in cleanrooms, for machine covers, for incubators, for displays, for display screens and display-screen covers, for rear-projection screens, for medical apparatus and for electrical devices.
